(19) United States
(12) Patent Application Publication
(10) Pub. No.: US 2025/0252804 A1
(43) Pub. Date: Aug. 7, 2025

(54) COMBINED SYSTEMS FOR CORRECTIONAL FACILITY MANAGEMENT

(71) Applicant: T.W. Vending Inc., River Falls, WI (US)

(72) Inventors: Sam Bengtson, River Falls, WI (US); Eric Bloms, Hudson, WI (US)

(21) Appl. No.: 19/044,128

(22) Filed: Feb. 3, 2025

Related U.S. Application Data
(60) Provisional application No. 63/549,125, filed on Feb. 2, 2024.

(51) Int. Cl. G07F 9/00; G07F 9/02; G07F 19/00; H04L 9/40; H04L 51/42

(52) U.S. Cl. CPC G07F 9/009; G07F 9/02; G07F 19/202; H04L 51/42; H04L 63/306

(57) ABSTRACT

The present disclosure relates to systems and methods for secure facility management. More specifically, the present disclosure provides telecommunications, email, other messaging, financial services, vending, and commissary or canteen services for inmates of a secure facility with respect to family, friends and others. The system and methods disclosed herein also provide facial recognition and artificial intelligence subsystems.

### TECHNICAL FIELD

The present disclosure relates, generally, to integrated systems for coordinated management of various functions of secure facility systems, including telecommunications, commissary, inmate recognition, back-end functions and associated apparatus and methods. Such systems can be used in any of a variety of secure facilities such as a jails, institutions, prisons or the like. The disclosure also describes audio-visual telecommunications services for users of a secure facility and rules and requirements for the same.

### BACKGROUND

Secure facility management systems face numerous challenges that hinder their effectiveness in ensuring the rehabilitation and security of inmates. One significant issue is the outdated and inefficient technology infrastructure used in many secure facilities. Many systems still rely on legacy software and hardware, making it difficult to implement modern solutions that could enhance operational efficiency and inmate management. This technological lag not only impedes the overall effectiveness of secure facilities but also poses security risks as outdated systems may be more vulnerable to cyber threats.

Additionally, many secure facilities struggle to tie together different aspects of secure facility management, with older technology that is unable to effectively communicate with newer systems. The inability to have a comprehensive, robust, and complete secure facility management system adds costs and time to staff and personnel who need to work to share information across systems.

Therefore, there is a need for a system that communicates across facility functions, and is capable of housing various subsystems of the secure facility management technology on one platform.

### SUMMARY

According to a first aspect, a secure facility management system described herein includes an interface, an artificial intelligence system with various subsystems, a messaging subsystem, the messaging subsystem having a request process to allow staff to submit the response as pending or closed, monitor incoming and outgoing messages to approve or deny, and approve or deny picture messages. The messaging subsystem may be coupled to the interface. The system also includes an artificial intelligence message monitoring system, a subsystem enabling automatic approval or denial of incoming messages that may not be appropriate content for a facility based on preset criteria adaptable for each facility. The system also includes an artificial intelligence message response system, a subsystem enabling automatic response to internal inmate requests, including but not limited to, legal information, facility information and inmate information. The artificial intelligence system with subsystems is used to assist with finances, security, investigations, and other subsystem, enabling automatic, enhanced, and more in-depth analysis of internal facility finances and cross-functions for the entire system.

Referring again to the first aspect, the system may include a depositing subsystem, the depositing subsystem enabling trust deposits, a lien monitoring function, a bail depositing function, and an escrow function, the depositing subsystem being coupled to the interface. The system includes a merge subsystem, wherein a master account is selected, followed by selecting a merged account, the merge subsystem allowing a direct review of basic toggle of balances together or the review of a “more” toggle subsystem, the more toggle subsystem allowing the user to view, for example, how many SMS, emails, phone calls, video requests, vending requests, movies, games, other requests, transactions, MP3s, and liens will be transferred over to the master account, the merge subsystem being coupled to the interface.

In examples, the system includes a facial recognition subsystem, the facial recognition subsystem enabling staff to have a picture of an inmate within the correction facility management system to verify and keep track of the inmate account if another inmate has a same name, wherein the inmate can log into a kiosk with the facial recognition subsystem and without a pin, and wherein the facial recognition subsystem is coupled to the interface. The facial recognition subsystem enhances inmate security by preventing pin-sharing, pin-stealing, and theft, and increasing the ability to identify the user. In examples, the system includes a contact restriction subsystem with two contact restriction levels, wherein contact data is separated into a first level being a site level on the storage medium, and a second level being an inmate level on the storage medium, wherein the contact restriction subsystem s restricts inmates from certain contact information such as information about other inmates, email address, phone numbers, or a combination thereof, the contract restriction coupled to the interface. In one example, each subsystem of the secure facility management system interacts on the interface that is present on each computer in the secure facility and can be synced between secure facilities. For example, the secure facility management system may intelligently communicate from one facility to the next, between multiple facilities, or accessed remotely.

In some examples, the system includes an electronic mail scanning.

In another example, the system may use a mobile host for all of the subsystem s.

In another example, the artificial intelligence monitoring system is programed to approve or deny specific content, such as words or phrases, gang signs, or explicit picture content. The artificial intelligence monitoring system can complete the approval or denial for both messaging, and video visitation content. The system may include subsystem s that blank out the screen or cover up graphics containing explicit picture content. In examples, the artificial intelligence monitoring system is customizable, depending on the secure facilities requirements.

In another example, the assistant allows for written questions to be inputted into a subsystem.

In another example, the system further includes the financial assistant analyzing a request and providing a human-readable written response based on data and context of the request.

In another example, the depositing subsystem includes selecting a deposit type, including a manual cash deposit, a cashbox deposit, a check deposit, or a split deposit.

In another example, the system includes a discipline subsystem. The discipline subsystem may allow for selection of a start date, an end date, and any notes based on the discipline.

According to a second aspect a method described herein can include processing messages through a messaging subsystem, the messaging subsystem allowing for a response by staff of approving or denying pending messages, monitoring a depositing subsystem, the depositing subsystem including trust deposits, a lien function, a bail depositing function, and an escrow function, merging one or more accounts, allowing a user to view how many SMS, emails, requests, transactions, MP3s, and liens will be transferred over to a master account to monitor the one or more accounts under one merged account, enabling a facial recognition subsystem to allow an inmate to access a kiosk without entering a pin, and for staff to account for inmates with similar names by using the facial recognition subsystem, and restricting contact information from inmates, the contact restriction featuring two levels, wherein contact data is separated into a first contract restriction level being a site level on a storage medium, and a second contact restriction level being an inmate level on a storage medium.

In another example, the method further includes approving or denying a picture message under a separate section.

In another example, the monitoring of the depositing subsystem involves one or more of the following deposit types: manual cash deposit, cashbox deposit, a check deposit, or a split deposit.

In another example, the method further includes running a report.

In another example, the method includes downloading a hardware interface.

In another example, the facial recognition subsystem further includes associating details captured from a face with another, then associates this with a unique inmate identifier (idInmate). idInmate is a number that uniquely identifies an inmate record that can include an association to a name, DOB, and other information. name.

In another example, the method includes automatically replying to certain messages with an artificial intelligence response system.

In another example, the method includes a vending subsystem, the system including a subsystem to automatically refund an inmate if an item from vending is out of stock. Vending includes a subsystem to refund an inmate if an item is out of stock (this includes during the ordering process or once the order is being filled and the system recognizes the item is out of stock).

A variety of additional inventive aspects will be set forth in the description that follows. The inventive aspects can relate to individual subsystem s and to combinations of subsystem s. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. The drawings depict elements of this disclosure for a more complete understanding of the secure facility management system, but additional embodiments and examples may be possible.

A brief description of the drawings is as follows:

FIG. 1 is a diagram showing an embodiment of a system for providing telecommunications, email, other messaging, financial services, vending, and commissary or canteen services for inmates of a secure facility with respect to family, friends and others;

FIG. 2 depicts a system a secure facility management system 100;

FIG. 3 depicts an extension of the system of FIG. 2, including a data entry system 120;

FIG. 4 depicts a method of using the secure facility management system of FIG. 2;

FIG. 5 depicts and artificial intelligence (AI) management system;

FIG. 6 depicts one example of a suitable operating environment including network PCs, minicomputers, mainframe computers, tablets, or distributed computing environments that include any of the above systems or devices, and the like;

FIG. 7 depicts a graphical user interface corresponding to a vending system implementing the system of FIG. 2; and

FIG. 8 depicts a method for performing an operation of the messaging system of the system of FIG. 2.

### DETAILED DESCRIPTION

Various examples will be described in detail with reference to the drawings, wherein like reference numerals represent like parts and assemblies throughout the several views. Reference to various examples does not limit the scope of the claims attached hereto. Additionally, any examples set forth in this specification are not intended to be limiting and merely set forth some of the many possible embodiments for the appended claims.

In examples herein, a secure facility management system and methods are described. The secure facility management system incorporates subsystem s to enable communications, financial transactions, delivery of goods and services, inmate monitoring, and several other aspects. The secure facility management system houses each of the subsystem s on a centralized interface, that is cloud-based and that may be used in any secure facility tied to the system, and on any device within the secure facility or without for the purpose of inmate monitoring. The method of using the secure facility management system allows for each of the subsystem s to communicate intelligently, and incorporate information from different areas of the system.

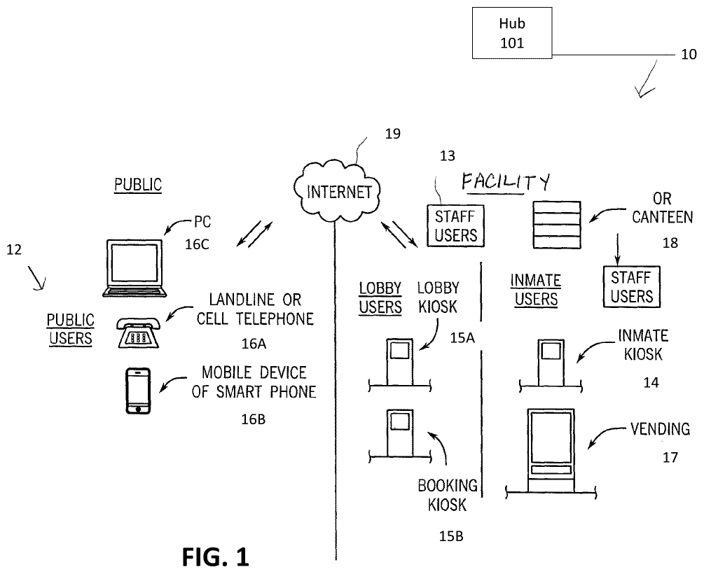

Prison or jail systems include a variety of subsystems as described in Applicant's earlier publication, US 2014/0219432, the contents of which are hereby expressly incorporated by reference in their entirety. FIG. 1 shows an embodiment of the system 10 of the disclosure for providing communications, financial transactions and delivery of goods and services between an inmate 11 and family member 12 at the inmate facility (such as the booking area or the lobby of the jail) or remote from the facility (such as a home or work location), and which can be monitored and controlled by a facility administrator(s) 13. The system 10 provides telecommunications (voice, text, email, and in some cases audiovisual) between a person (for example an inmate) inside a closed facility (for example a jail, work house, detention center, prison or the like) with one or more persons (for example family, spouse, children, friends or the like) outside the facility (for example in the lobby of the facility, booking station of the facility, or completely outside the facility such as home, work or public place either in the community of the facility or even outside the city, state or country of the facility). The system is capable of monitoring inside-to-outside communication, inside-to-inside communication, and outside-to-inside communication.

The inmate uses an inmate kiosk 14 inside the secure section of the secure facility to send and receive telecommunications. The particulars of the device and the type of data are not limiting on the invention, but various examples are provided for the purposes of fully describing various embodiments. The other person receiving or sending communications may use a lobby kiosk 15a or a booking kiosk 15b inside the facility, but outside the secure section thereof (i.e. a lobby or booking kiosk 15a/b), or a land line type or cell type telephone 16a for video, voice or SMS text, a smart mobile phone 16b for voice, text, email or AV, or a PC 16c or other computer for email or AV.

The system 10 also provides means for family or friends to electronically send or deposit funds or credits to the inmate that may then be used by the inmate to purchase or acquire telecommunication services of the system, vending of drinks, candy, snacks, personal items, or the like by way of one or more vending machines 17 inside the secure section of the facility or commissary 18 (aka “canteen”) items such as clothing, food, blankets and other larger personal items delivered by facility staff or administration, via so called “brown-bag” services. The system further provides a means for the facility staff or administration to monitor, record, and document communications and transactions between the inmate and his or her family, friends or others. The facility staff can safely and securely monitor communications for prohibited, illegal or unsafe activity, limit inmate access based on normal rules, funds or credit availability, or rule violations, and can suspend inmate accounts when warranted or necessary. Each aspect of the system may be independently turned on, or turned off without implicating other subsystem s of the system. For example, the recording and monitoring of communications may be turned off for attorney calls, without turning off any of the other messaging or call subsystem s.

Another embodiment of the system 10 of the invention uses various established technologies (including, but not limited to VoIP (voice-over-internet protocol), WebRTC (web real-time communication), RTMP (real-time messaging protocol), SIP (session initiation protocol), RTSP (real-time streaming protocol), and others) to communicatively connect the kiosks 14 and 15, staff hardware (not shown) and users 12 of PCs 16c, land line telephones 16a and mobile phones and other mobile devices such as smart phones 16b. Each of the above technologies encompass the communication protocols, peer to peer apps, technologies, methodologies, and transmission techniques involved in the delivery of voice communications and multimedia sessions over Internet Protocol (IP) networks, such as the Internet 19. Internet telephony refers to communications services—voice, SMS, and/or voice-messaging applications—that are transported via the Internet, rather than the public switched telephone network (PSTN). Internet telephony may further include video communications. The steps involved in originating an outgoing telephone call are signaling and media channel setup, digitization of the analog voice signal, encoding, packetization, and transmission as Internet Protocol (IP) packets over a packet-switched network. On the receiving or incoming side, similar steps (usually in the reverse order) such as reception of the IP packets, decoding of the packets and digital-to-analog conversion reproduce the original voice stream.

Even though IP telephony and VoIP are used interchangeably, IP telephony refers to all use of IP protocols for voice communication by digital telephony systems (as listed above), while VoIP (or another selected system from above) is one technology used by IP telephony to transport phone calls. VoIP systems employ session control protocols to control the set-up and tear-down of calls as well as audio codecs which encode speech allowing transmission over an IP network as digital audio via an audio stream. The choice of codec varies between different implementations of VoIP, or the selected technology being used, and depending on application requirements and network bandwidth; some implementations rely on narrowband and compressed speech, while others support high fidelity stereo codecs. Some popular codecs include u-law and a-law versions of G.711, G.722 which is a high-fidelity codec marketed as HD Voice by Polycom, a popular open source voice codec known as iLBC, a codec that only uses 8 Kbit/s each way called G.729, and many others. VoIP is available on many smart phones and Internet devices so that users of portable devices that are not phones, may place calls or send SMS text messages over 3G or Wi-Fi.

The various subsystems of FIG. 1, including kiosks 14, 15A, and 15B, as well as commissary systems such as vending 17 and canteen 18, can be managed as described herein as a centralized system. Functionality from different systems, which heretofore may have been separate, can be combined as described with respect to the other figures. For example, commissary deposits may be made via a kiosk previously used for communications, and overarching systems such as facial recognition and approved/disallowed contacts can be used to facilitate the functioning of both commissary and kiosks. It should be understood that this is an example tying together only two of the subsystem s of a prison or jail management system, and that in other embodiments various other roles can be fulfilled by such systems. Efficiency and privacy of personal information can be maintained by use of artificial intelligence tools, which also facilitates better and faster service to both inmates and visitors.

Each of the various subsystems of FIG. 1 can be used from one facility to the next, between multiple facilities, or accessed by personnel remotely (staff, users, etc.).

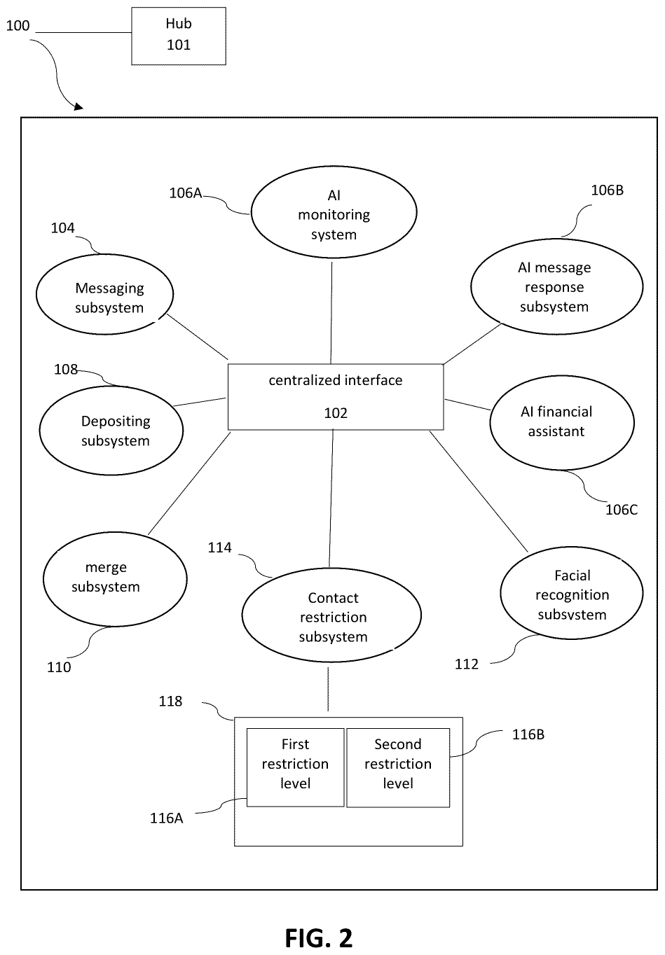

FIG. 2 depicts a secure facility management system 100, with various subsystems optionally hosted on a web-based hub 101, or an application programming interface (API). The secure facility management system 100 may include a messaging subsystem 104, an AI monitoring system 106A, an AI message response subsystem 106B, an AI financial assistant 106C, a depositing subsystem 108, a merge subsystem 110, a facial recognition subsystem 112, and a contact restriction subsystem 114. Each of the subsystems (104-114) may be tied or housed on a centralized interface 102. The centralized interface 102 allows the subsystem s to communicate intelligently across more than one secure facility, and with one and other. In embodiments, the centralized interface 102 can include anonymization subsystem s that permit sharing of information across an institution or multiple institutions. For example, inmate information can be saved in object-oriented format so that only elements of those objects that are necessary to carry out the functionality are shared, while private information is not shared when unneeded.

The AI monitoring system 106A, and the AI subsystems of the secure facility management system 100 more generally (106A, 106B, 106C, 132) operate off of an artificial intelligence model that is close-looped. The artificial intelligence system (including 106A, 106B, 106C, 132) is routinely updated internally with information relevant to the secure facility management system 100 but is not fed information from open-source material. Examples of information could include new policies, new content for flagging, new security protocols, changes in security, protocols, or policies. Additional information relevant to the facility or its functions may be updated as needed, and the information may be customizable from one facility to the next. For that reason, the secure facility management system is very personalizeable, secure, and able to intelligently respond to situations that are specific to any facility that the secure facility management system is used in.

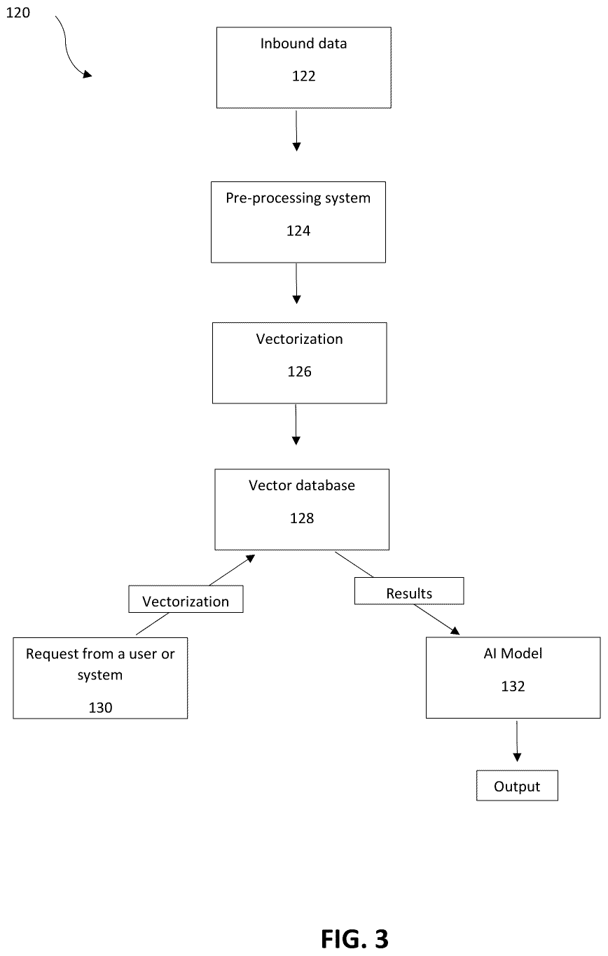

FIG. 3 is an extension of FIG. 2 and builds off of subsystem 106A (the AI monitoring system), 106B (the AI message response subsystem), and 106C (the AI financial assistant). The secure facility management system 100 also includes a data entry system 120. The data entry system 120 collects inbound data 122 which includes but is not limited to video recordings, call recordings, customer service requests, written inmate messages, or other forms of communication. The inbound data 122 is then sent through a pre-processing system 124 to convert the inbound data 124 to a mathematical representation.

After the inbound data 122 is sent through a pre-processing system 124, and the pre-processing system 124 converts the inbound data 122 to a mathematical representation, it then undergoes vectorization 126 and enters the vector database 128. After vectorization 126, a vector database 128 is created as an engine to store the computation from the vectorization 126. The vector database 128 identifies possible information matches based on the inbound data 122, feeding it into an AI model 132 which then reads the vectored data and provides a response for an end user.

On an opposite side of the data entry system 120, a user may ask for information on calls made within the facility. The data entry system 120 is able to automatically approve or “flag” calls and messages. The user request 130 undergoes vectorization, and the data entry system determines how close the user request 130 is to existing data within the vector database 128. This two-way feed of the data entry system allows for the AI model 132 to use both inbound data, and previously stored data to complete requests and intelligently respond automatically. The AI model 132 encompasses subsystem s of 106A-106C, as well as additional AI modalities to complete requests and automate processes.

The flagging subsystem of the data entry system 120 automatically “flags” or identifies calls/messages/images/or recorded transcripts for further review. In some examples, staff or personnel may review the flagged content to determine next steps. In other examples, the flagged content is automatically responded to, based on predetermined responses and outcomes built into the data entry system 120. If flagged content is marked as information that should be removed, or have a certain outcome tied to it, the system may intelligently respond to remove the content without further review. For example, privileged conversations may be identified based on the phone numbers used, voice recognition, facial recognition, or other data received at the data entry system 120 that prevents processing, analysis, or recording that content.

In an example, the system 100 may include memory configured with master account information that houses all information related to an inmates deposit account, and other information. Through a sequence of steps, multiple accounts may be merged using a merge subsystem 110. The merge subsystem 110 involves selection of a master account, followed by selecting a merged account. The merge subsystem 110 allows a direct review of basic toggle of balances together, or for a review of a “more” toggle. The “more” toggle allows the user to view how many SMS, emails, grievance requests, movies, games, transactions, MP3s, and liens will be transferred over to the master account, the merge subsystem 110 being coupled to the interface 102. Each of the listed subsystem s may be toggled on and off in the system. This allows for customized use by each user and facility to only use certain subsystem s and functions. The toggle subsystem is also advantageous for facilities that may want to use some subsystem s of system 100, but do not require others. The merge subsystem 110 is helpful for piecing together several pieces of separate information on the system 100, to be viewed under one comprehensive tab for efficiency, and to ensure that staff and personnel do not miss anything when reviewing information related to an inmate. Merge subsystem 110 therefore enables the use of the system 100 in a software-as-a-service (SaaS) context, as different correctional facilities may need different subsystem s, have different regulations that require different handling of data, or have different budgets, local hardware, or other differences that makes customization using the master account attractive.

In examples, the system also includes a facial recognition subsystem 112. The facial recognition subsystem enables various functionality throughout the entirety of the systems described herein. For example, facial recognition subsystem 112 can both help staff to identify an inmate within the correction facility management system to verify and keep track of the inmate account, regardless of name or other biographical information, but also act as a form of key for functionality that does not require staff intervention, such as a phone calling system. In examples, the inmate can log into a kiosk (e.g., kiosks 14, 15A, 15B of FIG. 1) with the facial recognition subsystem 112 either with or without a pin to ensure that the correct individual is accessing the kiosk and did not simply use another inmates pin. The facial recognition subsystem 112 increases inmate safety by safe-guarding and preventing pin-sharing, pin-stealing, and theft. This is particularly important as it is common that an inmate may have restrictions on whom he or she is permitted to contact in view of restraining orders or judgments, such that PIN sharing could otherwise provide a workaround that would circumvent these restrictions. The facial recognition subsystem 112 may also be coupled to the interface 102. In this way, facial recognition can be used to prevent both impermissible communications, but also disable access to any of the other modules in system 100 that an inmate could otherwise access if he or she obtained access to another inmate's PIN.

In an example, the system 100 has a contact restriction subsystem 114. The contact restriction subsystem 114 may have two or more contact restriction levels, with contact data being separated into a first level (116A) at a site level on a storage medium 118, and a second level (116B) being at an inmate level on the storage medium 118. The contact restriction subsystem 114 restricts inmates from certain contact information such as information about other inmates, email address, phone numbers, or a combination thereof. The contract restriction subsystem 114 may be coupled to the interface 102.

In the above example, the contact restriction subsystem 114 may also be especially useful for situations of legal proceedings, no-contact orders, restraining orders, or previous situations of hostility or problematic behavior. Staff and personnel may input settings on the system 100 to use the contact restriction subsystem 114 to prevent the contact of individuals within the facility at the first level 116A, or from contact from outside individuals at the second level 116B. In some embodiments, hub 101 can be networked to systems such as a court system, a secure facility server, or other source of information pertaining to restraining orders or other loss of contact privileges so automatically update the contact restriction subsystem 114.

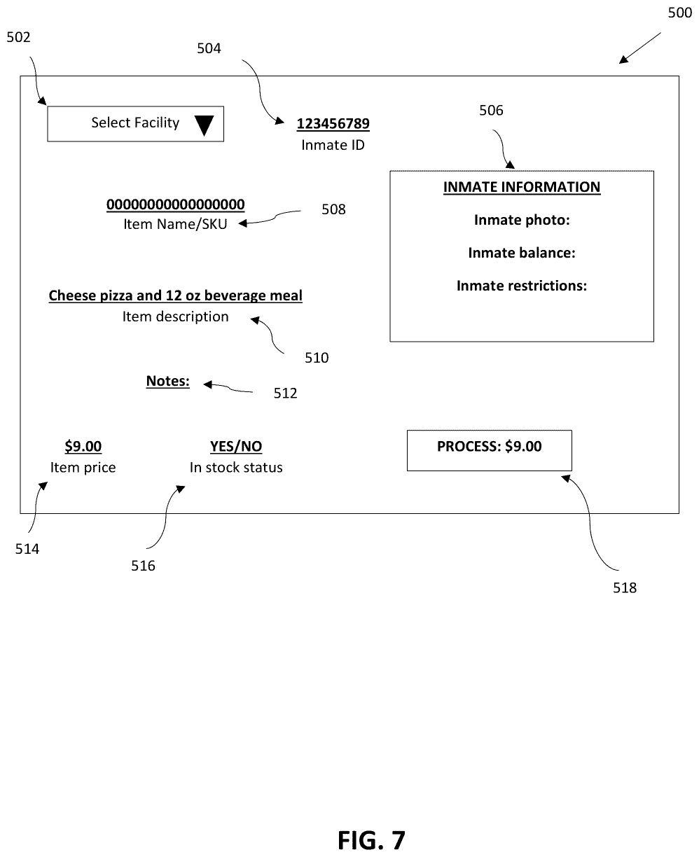

In embodiments, the messaging subsystem 104 (a method of which is shown in FIG. 7) incorporates several capabilities to enable communication both within the secure facility, and for inmates and individuals outside of the secure facility to communicate. The messaging subsystem 104 can include several safety related aspects, to protect the secure facility, the inmates, any privileged information, outside people the inmate is restricted from contacting, and the individual the inmate may be communicating with. These safety subsystem s can either be set manually, or in some embodiments can use pattern recognition or scrape court information to set privacy and protection rules.

In one example, the messaging subsystem 104 allows staff to view requests and respond to any message requests. The request process allows the staff to submit the response as pending or closed. Staff can monitor incoming and outgoing messages from family and friends. Then, the facility can even review the messages by approving or denying. Messages containing pictures will be listed under the “all messages,” tab of the message interface but under their own section. Staff can see, approve, or deny the pending pictures. AI monitoring system 106A can be trained using these approvals or denials and the underlying pictures to provide a recommendation for staff, or to identify a list of suspect messages that require further staff review. AI monitoring system 106A can be trained using data that includes not just the messages or images, but also sender and recipient information, pattern recognition in who the messages are sent to and when, and other information that could be indicative of activities such as harassment, coded messaging, or other behavior that may not be immediately apparent from review of a single message or image. This also will add security to interactions as well as speed up the review process for staff.

In another example, the messaging subsystem 104 allows for posting of a “message of the day” which may be customized by staff members using the secure facility management system 100. Setting a message of the day includes setting the start date and end date. The message can be anything for the inmates to read and made aware of. Messages of the day may be different based on whether they are subsystem d on an inmate kiosk or a lobby kiosk. AI pattern recognition can detect and identify new gang symbols, code phrases, or patterns indicative of violations of law or correctional facility policy without explicit training. This can be accomplished through AI pattern recognition tools using all of the various channels of communication that are available via system 100. In embodiments, combined patterns (e.g., code words spoken in phone calls in the days subsequent to unusual transactions in commissary) could be used to detect illicit activity.

In examples, the contact restriction subsystem 114 may include a first restriction level 116A, and a second restriction level 116B, which may be located on a storage medium 118. The first restriction level 116A may be a “site level,” and the second restriction level 116B may be an “inmate level.” For each of the restriction levels (116A, B) housed on the storage medium 118, there may be an option to add a reason for the restriction, and to log a start date and end date.

In one example, the first restriction level 116A may restrict an inmate from accessing certain areas or aspects of the facility. The second restriction level 116B may restrict an inmate from contacting or being contacted by specific individuals. The second restriction level 116B may be especially useful for situations of restraining orders, ongoing legal cases that require no-contact, no-contact orders themselves, and any other situations that would result in illegality or hostility.

The contact restriction subsystem 114 provides a medium to input various information that can include email address, inmate canteen user, inmate, phone number(s), and the team user. This information may be shred from facility to facility, and within all of the subsystem s included in the secure facility management system 100.

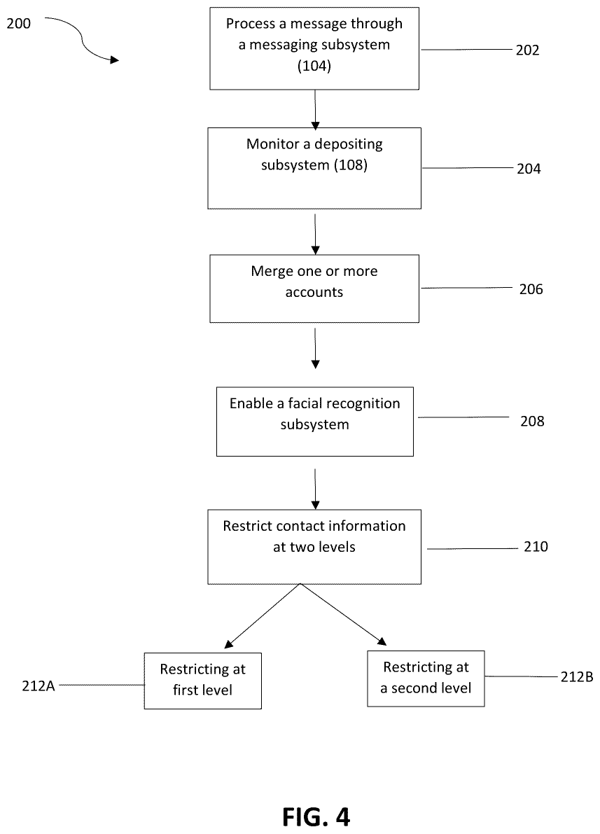

FIG. 4 depicts a method of using the secure facility management system of FIG. 1, with a first step of processing a message through a messaging subsystem 202. The secure facility management method 200 may also allow for monitoring a depositing subsystem 204, merging one or more accounts 206, enabling a facial recognition subsystem 208, and restricting contact information at two separate levels 210. The two levels of contact information restriction may take place as a first level 212A, and a second level 212B.

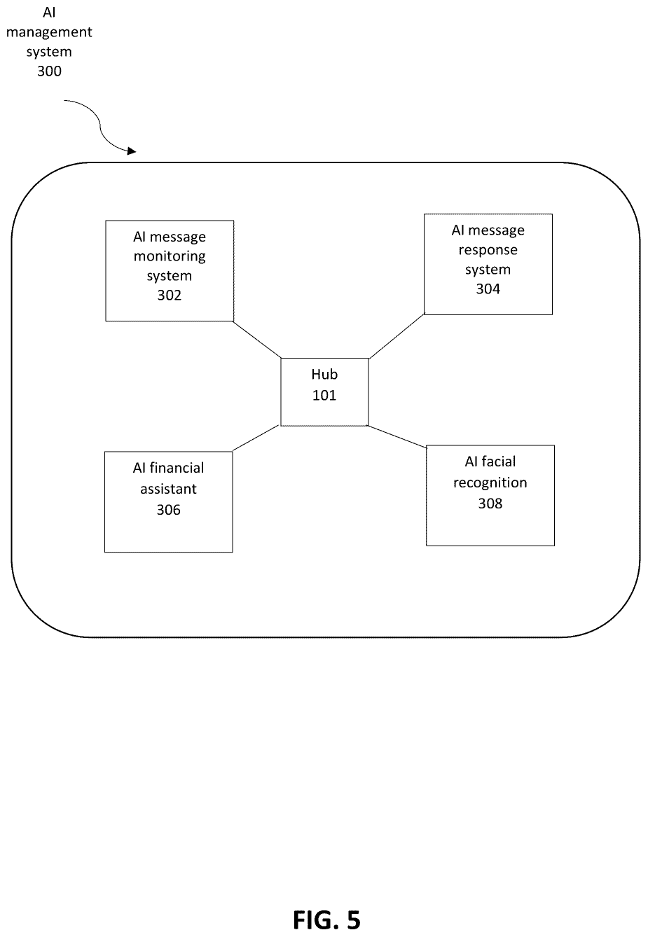

Referring now to FIGS. 1 and 5 concurrently, the secure facility management system 100 includes several AI capabilities (106A,B,C), that may also be seen in FIG. 4, which illustrates the AI management system 300. The AI management system 300 recognizes, coordinates and implements each of the AI subsystem s used by the secure facility management system 100. Optionally, the elements of the AI management system 300 may be housed on the hub 101, a mobile-based application that facilitates simultaneous management of each aspect of the AI management system 300.

The AI management system 300 may include additional AI capabilities not included in FIG. 5. In an example, the AI management system 300 includes: an AI message monitoring system 302, an AI message response system 304, and AI financial assistant 306, and an AI facial recognition subsystem 308. The AI message monitoring system 302 and the AI message response system 304 communicate to receive, screen, analyze, and prepare responses to messages. Due to the complex nature of the messages being sent and received, the capabilities of the AI management system 300 provide efficiency and additional levels of security and screening. Additionally, the AI management system 300 may pull data from disparate sources to identify patterns across multiple data streams, which may not be apparent or understandable if taking data only from a single data stream.

In examples, the AI financial assistant 308 may communicate both with internal finances, as well as inmate finances. Therefore, the AI financial assistant 308 may communicate with the depositing subsystem 108 of FIG. 1 in some examples. The AI financial assistant 308 may track inmate deposit accounts, including keeping track of amounts deposited and withdrawn, any balances owed, and other financial information.

In one example, the AI message monitoring system 302 may enable automatic approval or denial of incoming messages based on preset criteria. The preset criteria may be messages or pictures that are deemed to not be appropriate content for a facility, or material from an inappropriate outside party by screening for who is on the call. Such content may include, but is not limited to, words or phrases, explicit picture content such as nudity, gang signs, hand gestures, or other objects, messaging, or content. The system involves a subsystem to approve individuals that are no longer monitored, for example, secure officers may not have screening subsystem s used with their accounts. Toggles can be implemented to determine what content is being monitored. Further, the AI message monitoring system 302 may be customizable per facility requirements and vary from facility to facility.

The AI message response system 304, may enable automatic response to internal inmate requests, including but not limited to, legal information, facility information and inmate information.

The AI financial assistant 306, may enable automatic analysis of internal facility finances. The AI financial assistant 306 allows for written questions to be input into a subsystem. The AI financial assistant 306 then analyzes the request and will provide a human readable, written response based on the data and context of the request.

The AI management system 300 oversees various functions and services of the secure facility management system 100. The AI management system 300 includes many subsystem s, for example (but not limited to) analysis of phone time, who is calling, what is discussed on the call, investigative tools, review and synopses of each phone call in real time (for both video and audio calls), planning (warehousing, trends, ordering, vending use, factoring in holidays and trends for the secure facility management system 100 to attach).

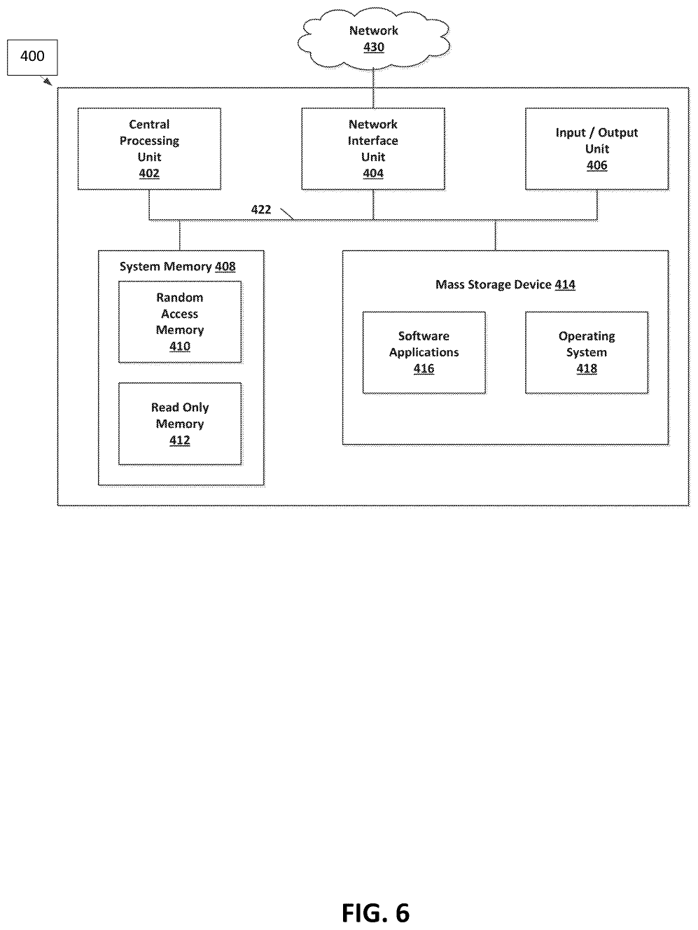

Referring now to FIG. 6, an example block diagram of a computing system 400 is shown that is useable to implement aspects of the secure facility management system 100. In the embodiment shown, the computing system 400 includes at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system that contains the basic routines that help to transfer information between elements within the computing system 400, such as during startup, is stored in the ROM 412. The computing system 400 further includes a mass storage device 414. The mass storage device 414 is able to store software instructions and data.

The mass storage device 414 is connected to the CPU 402 through a mass storage controller (not shown) connected to the system bus 422. The mass storage device 414 and its associated computer-readable storage media provide non-volatile, non-transitory data storage for the computing system 400. Although the description of computer-readable storage media contained herein refers to a mass storage device, such as a hard disk or solid-state disk, it should be appreciated by those skilled in the art that computer-readable data storage media can include any available tangible, physical device or article of manufacture from which the CPU 402 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing system 400.

According to various embodiments of the invention, the computing system 400 may operate in a networked environment using logical connections to remote network devices through a network 430, such as a wireless network, the Internet, or another type of network. The computing system 400 may connect to the network 430 through a network interface unit 404 connected to the system bus 422. It should be appreciated that the network interface unit 404 may also be utilized to connect to other types of networks and remote computing systems. The computing system 400 also includes an input/output controller 406 for receiving and processing input from a number of other devices, including a touch user interface display screen, or another type of input device. Similarly, the input/output controller 406 may provide output to a touch user interface display screen or other type of output device.

As mentioned briefly above, the mass storage device 414 and the RAM 410 of the computing system 400 can store software instructions and data. The software instructions include an operating system 418 suitable for controlling the operation of the computing system 400. The mass storage device 414 and/or the RAM 410 also store software instructions, that when executed by the CPU 402, cause the computing system 400 to provide the functionality discussed in this document. For example, the mass storage device 414 and/or the RAM 410 can store software instructions that, when executed by the CPU 402, cause the computing system 400 to display a GUI.

FIG. 7 depicts a vending system for commissary ordering, on vending display system 500. The vending display system 500 may include several toggles and subsystem s to facilitate the ordering and fulfilment of items from a vending kiosk or commissary system. The first toggle or selection may be a facility selection 502, where a user selects which secure facility they are ordering from. Next, a user would input an inmate ID 504 to ensure that commissary funds are deducted from the correct depositing account. The vending display system may also have an inmate information section 506, which includes information about any restrictions, account balances, discipline, or other subsystem s that may limit the inmates vending and commissary privileges and abilities. The vending display system 500 also incorporates an item name/sku 508 section, an item description 510, an item price 514, and an availability status 516 message for the item.

All of the listed subsystem s of the vending display system 500 may be housed on the central interface 102 of the secure facility management system 100. This integration allows for real-time tracking of inventory, ordering, picking, and fulfilment of commissary orders from vending kiosks. It also incorporates aspects from the depositing subsystem 108 to ensure there are adequate funds to complete an order. If the item is available, there are no restrictions, and the inmate has adequate funds, a process button 518 may be selected to complete fulfillment of the order. Finally, the vending display system 500 may include a notes section 512 for staff or personnel to input information related to the transaction.

Additional subsystem s related to vending may include a picking system in the warehouse. The picking system automatically picks, or selects the items from an order to more efficiently and quickly fill orders. The picking system completes the order, and the order is then transported from the warehouse, through the jail, and to the specific jail management system to be delivered to the inmate or user. The vending machines themselves allow for an entire order to be ordered, selected, and filled at one time. Items do not be ordered or selected in separate transactions, as multiple items can be included in one single ordering attempt.

In one example, vending kiosks may use the same system to recognize the inmate. When an inmate uses the vending kiosk, the kiosk will tell the inmate which products are available in the kiosk, as well as which items the inmate is able to buy, versus restricted from buying. The vending kiosks use inmate recognition to determine what restrictions may be imposed on items the inmate can, or cannot purchase from the kiosk. For example, restrictions may exist based on age, health, privileges based on conduct, legal implications, and others. A specific example, would be an inmate needing to be at least 18 years old to purchase tobacco products from a vending kiosk. Once the vending kiosk identifies the inmate, it consults the system data to determine the inmates age, and any other holds/implications/restrictions on their inmate account.

The system creates a unique identifier/algorithm based on the visual recognition of their face, and the identifier is used to identify the inmate with all of the systems while they are in the jail. The algorithm may be non-reversible, and the visual imaging of the inmate may not be replicated or reverse-engineered.

The system ultimately recognizes the face of an inmate and creates algorithm that is then used to create a link between the face and the inmates account. Therefore, the data created by the algorithm formed during the facial recognition, is preserved and linked to the other operations/ordering and use of the various tools in the system.

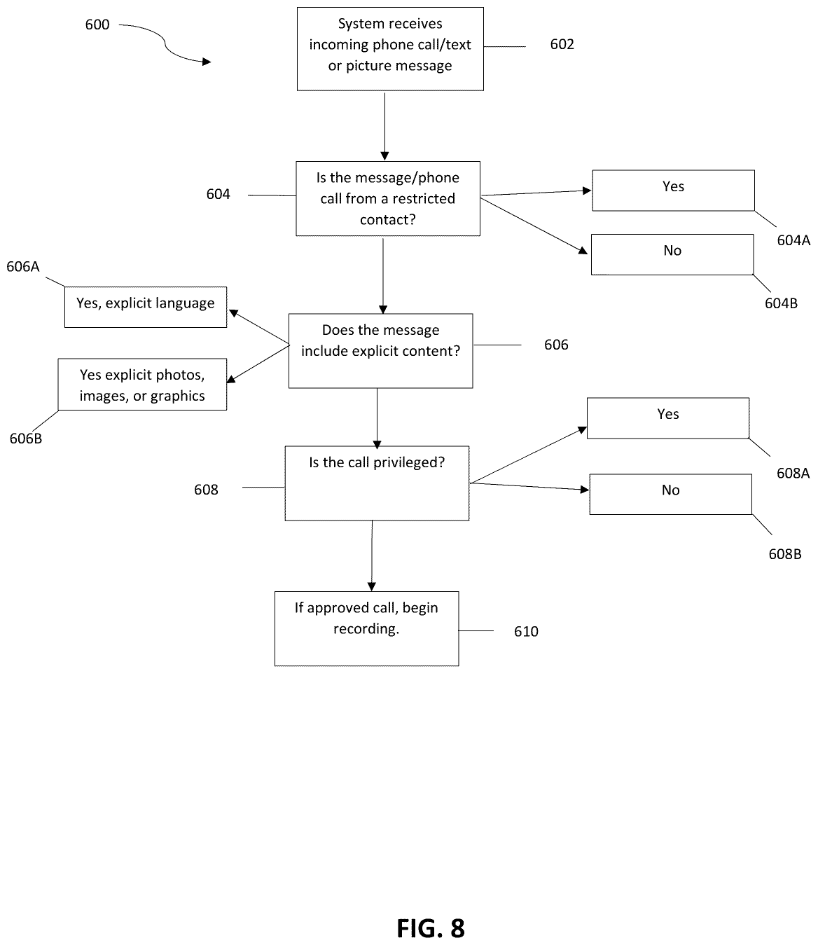

FIG. 8 depicts a messaging system 600, for processing and allowing or denying messages that come through the system 100. The messaging system 600 receives a message 602, and first decides whether or not the message is from a restricted contact 604. If yes (604A), the message will be flagged and denied 614. If no (604B), the message will continue to be processed toward approval 612. Next, the system 600 will determine whether or not the message contains explicit content 606. There are two key areas of content the system 600 may check for: explicit language 606A, and explicit images 606B.

If there is no explicit content 606, then the message will be analyzed for whether or not it is privileged 608, or contains privileged information. If yes 608A, the message will not be recorded 610, but will proceed. If no 608B, the message will proceed to be recorded 610 based on the above analysis.

Explicit content 606 may include language 606A, or images 606B as discussed above. For example, explicit content 606 related to language 606A may be vulgar, gang related, drug related, or otherwise inappropriate language for a secure facility. Explicit images 606B may be images that depict violence, nudity, symbols related to gangs, or other content that is deemed inappropriate by a secure facility. Explicit content 606 may also include any material that may be used to detect patterns indicative of criminal activity. For example, coded messages, cryptic graphics, or sequences of messages that may be tied to criminal activity.

In some examples, explicit content 606 may be coded and identified differently from one facility to the next. For example, one secure facility or user may have certain gang related images 606B or language 606A based on demographics, location, or other factors. Staff and personnel may feed or input data into the secure facility management system 100 to be identified by the AI management system 300 and a response will be provided based on predetermined outcomes and responses for selected content.

According to another example, any of the subsystem s and capabilities discussed in FIGS. 1-8 may be housed on, or incorporated on a mobile-based hub 101. The hub 101 allows for control of any of the aspects of the system 100 from a web-based application. Each of the subsystem s may be edited, manipulated, or controlled from a mobile device, rather than a computer-based system. The hub 101 facilitates seamless integration of all of the subsystem s of the system 100. The hub 101 also allows for staff and personnel to control aspects of the system 100 while moving about the secure facility, or in situations where it may be challenging for them to leave a location or situation, and access a computer within the facility.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For example, while certain technologies described herein were primarily described in the context of queueing structures, technologies disclosed herein are applicable to data structures generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

In the drawings, some structural or method subsystems may be shown in specific arrangements and/or orderings. However, it should be appreciated that such specific arrangements and/or orderings may not be required. Rather, in some examples, such subsystem s may be arranged in a different manner and/or order than shown in the illustrative figures. Additionally, the inclusion of a structural or method subsystem in a particular figure is not meant to imply that such subsystem is required in all examples and, in some examples, may not be included or may be combined with other subsystem s.

References in the specification to “one example,” “an example,” “an illustrative example,” etc., indicate that the example described may include a particular subsystem, structure, or characteristic, but every example may or may not necessarily include that particular subsystem, structure, or characteristic. Moreover, such phrases are not necessarily referring to the same example. Further, when a particular subsystem, structure, or characteristic is described in connection with an example, it is submitted that it is within the knowledge of one skilled in the art to affect such subsystem, structure, or characteristic in connection with other examples whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

From the forgoing detailed description, it will be evident that modifications and variations can be made in the aspects of the disclosure without departing from the spirit or scope of the aspects. While the best modes for carrying out the many aspects of the present teachings have been described in detail, those familiar with the art to which these teachings relate will recognize various alternative aspects for practicing the present teachings that are within the scope of the appended claims.

What is claimed is:

1. A system for management of a secure facility, the system comprising:
an interface;
a messaging subsystem coupled to the interface, the messaging subsystem having a request subsystem to allow staff to submit the response as pending or closed, monitor incoming and outgoing messages to approve or deny, and approve or deny picture messages;
a message monitoring subsystem for automatic approval or denial of messages based on preset criteria specific to the secure facility;
an artificial intelligence system with subsystems, the artificial intelligence subsystem including:
an artificial intelligence message response subsystem for providing automatic responses to internal inmate requests, including legally-privileged information, facility information and inmate information; and
an artificial intelligence subsystem for financial assistance, efficiency, monitoring internal facility functions, a subsystem enabling automatic analysis of internal facility finances;
a depositing subsystem, the depositing subsystem enabling trust deposits, a lien monitoring function, a bail depositing function, and an escrow function, the depositing subsystem being coupled to the interface.
a merge subsystem, wherein a master account is selected, followed by selecting a merged account, the merge subsystem allowing a direct review of basic toggle of balances together or you review of a more toggle, the more toggle allowing a user to view how many SMS, emails, requests, transactions, MP3s, and liens will be transferred over to the master account, the merge subsystem being coupled to the interface;
a facial recognition subsystem, the facial recognition subsystem enabling the secure facility management system to have a picture of an inmate within the secure facility management system to associate details captured from the picture with another, and associate that with a unique inmate identifier that uniquely identifies an inmate record that can include an association to a name, restrictions and privileges placed on their account, or date of birth, and wherein the inmate can log into a kiosk with the facial recognition subsystem and without a PIN, and wherein the facial recognition subsystem is coupled to the interface;
a contact restriction subsystem with two contact restriction levels, wherein contact data is separated into a first level being a site level on the storage medium, and a second level being an inmate level on the storage medium, wherein the contact restriction subsystem restricts inmates from certain contact information such as information about other inmates, email address, phone numbers, or a combination thereof, the contact restriction subsystem coupled to the interface; and
wherein each subsystem of the secure facility management system interacts on the interface and can be synced between secure facilities.

2. The system of claim 1, wherein the system further comprises an electronic mail scanning subsystem.

3. The system of claim 1, wherein the system a mobile host for all of the subsystems.

4. The system of claim 1, wherein the depositing subsystem further comprises an option to reopen an account.

5. The system of claim 1, wherein the artificial intelligence monitoring system is programed to approve or deny specific content, such as words or phrases, or explicit picture content.

6. The system of claim 5, wherein the artificial intelligence monitoring system is customizable, depending on the secure facilities requirements.

7. The system of claim 1, wherein the assistant allows for written questions to be inputted into a subsystem.

8. The system of claim 7, further comprising the financial assistant analyzing a request and providing a human-readable written response based on data and context of the request.

9. The system of claim 1, wherein the depositing subsystem further comprises selecting a deposit type selected from the list consisting of: a manual cash deposit, a cashbox deposit, a check deposit, or a split deposit.

10. The system of claim 1, further comprising a discipline subsystem.

11. The system of claim 10, wherein the discipline subsystem allows for selection of a start date, an end date, and any notes based on the discipline.

12. A method for using a secure facility management system, the method comprising:
processing messages through a messaging subsystem, the messaging subsystem allowing for a response by staff of approving or denying pending messages;
monitoring a depositing subsystem, the depositing subsystem including trust deposits, a lien function, a bail depositing function, and an escrow function;
merging one or more accounts, allowing a user to view how many SMS, emails, requests, transactions, MP3s, and liens will be transferred over to a master account to monitor the one or more accounts under one merged account;
enabling a facial recognition subsystem to allow an inmate to access a kiosk without entering a pin; and
restricting contact information from inmates, the contact restriction featuring two levels, wherein contact data is separated into a first contract restriction level being a site level on a storage medium, and a second contact restriction level being an inmate level on a storage medium.

13. The method of claim 12, further comprising approving or denying a picture message under a separate section.

14. The method of claim 12, wherein the monitoring of the depositing subsystem involves one or more of the following deposit types: manual cash deposit, cashbox deposit, coin deposit, or a check deposit.

15. The method of claim 12 further comprising running a report.

16. The method of claim 13, wherein the picture message can be manually approved by a staff member, or automatically screened and approved or denied by an artificial intelligence tool.

17. The method of claim 12, wherein the facial recognition subsystem further comprises using an artificial intelligence tool to differentiate inmates with the same name.

18. The method of claim 12, further comprising automatically replying to certain messages with an artificial intelligence response system.

19. The method of claim 12 further comprising a vending subsystem.

20. The method of claim 19, wherein the vending subsystem automatically refunds an inmate if an item from vending is out of stock.
